(19) United States
(12) Patent Application Publication
(10) Pub. No.: US 2006/0279513 A1
(43) Pub. Date: Dec. 14, 2006

(54) Apparatus and method for driving gate lines in a flat panel display (FPD)

(76) Inventor: Kyu-Young Chung, Seoul (KR)

Correspondence Address: F. CHAU & ASSOCIATES, LLC, 130 WOODBURY ROAD, WOODBURY, NY, 11797, US

(21) Appl. No.: 11/446,824

(22) Filed: Jun. 2, 2006

(30) Foreign Application Priority Data
Jun. 3, 2005 (KR) 10-2005-0047965

(51) Int. Cl. G09G 3/36

(52) U.S. Cl. 345/100

(57) ABSTRACT

Provided are an apparatus and method for driving the gate lines of a flat panel display (FPD). The apparatus for driving the gate lines of an FPD, includes: a first circuit converting a peak-to-peak level of an input pulse and outputting the converted input pulse as a first selection signal; and a plurality of second circuits generating a plurality of channel output pulses according to a plurality of second selection signals while the first selection signal is active.

### CROSS-REFERENCE TO RELATED PATENT APPLICATION

This application claims priority to Korean Patent Application No. 10-2005-0047965, filed on Jun. 3, 2005, in the Korean Intellectual Property Office, the disclosure of which is incorporated by reference herein in its entirety.

### BACKGROUND OF THE INVENTION

1. Technical Field

The present invention relates to a flat panel display (FPD), and more particularly, to an apparatus for driving the gate lines of an FPD.

2. Discussion of the Related Art

Flat Panel Displays (FPDs) encompass a growing number of technologies that are lighter and much thinner than traditional television and video displays using cathode ray tubes. Currently, there are a variety of different FPDs such as Thin Film Transistor-Liquid Crystal Displays (TFT-LCDs), Electro-Luminance (EL) display devices, Super Twisted Nematic-Liquid Crystal Displays (STN-LCDs), Plasma Display Panels (PDPs), and so forth.

Hereinafter, a TFT-LCD, which is a widely used FPD, will be described. FIG. 1 is a block diagram of a TFT-LCD 100 which includes a TFT-LCD panel 110 and peripheral circuits. The TFT-LCD panel 110 is composed of an upper plate and a lower plate, each including a plurality of electrodes for forming an electric field. A liquid crystal layer is inserted between the upper plate and the lower plate. Each of the upper and lower plates includes a polarization plate for polarizing light.

In the TFT-LCD 100, brightness is controlled by applying gray-level voltages to pixel electrodes to rearrange liquid crystal molecules. To apply a gray-level voltage to the pixel electrodes, a plurality of switching devices, such as TFTs, are arranged on the lower plate of the TFT-LCD panel 110. Brightness of a pixel is controlled by the switching devices so that the TFT-LCD panel 110 can display an image through a pixel array with a three-color filter arrangement of Red (R), Green (G), and Blue (B).

The TFT-LCD 100 includes gate drivers 120 for driving gate lines connected to the TFTs arranged on the lower plate, and source drivers 130 for driving source lines connected to the TFTs arranged on the lower plate. The gate drivers 120 and source drivers 130 are controlled by a controller (not shown). In general, the controller is disposed outside the TFT-LCD panel 110. In addition, the gate drivers 120 and the source drivers 130 are generally disposed outside the TFT-LCD panel 110. However, the gate drivers 120 and the source drivers 130 can be disposed on the TFT-LCD panel 110 in, for example, a Chip On Glass (COG) type panel.

FIG. 2 is a block diagram of a conventional gate driver 120. Referring to FIG. 2, the gate driver 120 includes a shift register (SR) 121, level shifters (LSs) 122, and buffers 123.

The shift register 121 includes a plurality of register cells C1, C2, C3, . . . The cells C1, C2, C3, . . . of the shift register 121 sequentially generate pulses when a start signal STP is activated. The pulses generated by the cells C1, C2, C3, . . . of the shift register 121 are converted in the level shifters 122 and peak-to-peak voltages of the pulses are increased. The converted pulses are then buffered in the buffers 123 and output as driving signals GL1, GL2, GL3, . . . for driving the gate lines of the lower plate of the TFT-LCD panel 110.

Each buffer 123 is designed to have a sufficient current driving capability so that it can properly drive a load of a corresponding gate line. As such, if the buffers 123 activate corresponding gate lines, the source drivers 130 output the R, G, and B image signals to the source lines, and the pixels of gate lines that receive the image signals rearrange liquid crystal molecules according to the corresponding gray-level voltages, thereby controlling the brightness.

However, in the conventional gate driver 120, a separate circuit is provided for each gate line channel. This increases the manufacturing cost, size, and power consumption of the conventional gate driver 120. Accordingly, there is a need for a gate driver that has a reduced size and power consumption.

### SUMMARY OF THE INVENTION

The present invention provides an apparatus and method for driving the gate lines of a flat panel display (FPD).

According to an aspect of the present invention, there is provided an apparatus for driving the gate lines of an FPD comprising: a first circuit converting a peak-to-peak level of an input pulse and outputting the converted input pulse as a first selection signal; and a plurality of second circuits generating a plurality of channel output pulses according to a plurality of second selection signals while the first selection signal is active. The plurality of channel output pulses are sequentially activated.

The input pulse is an output pulse of a shift register. The first selection signal is synchronized with a first control signal and the plurality of second selection signals are synchronized with a second control signal.

A frequency of the second control signal is higher than a frequency of the first control signal by a factor corresponding to a number of second circuits connected to the first circuit. The second control signal is low while the first control signal is high.

Active periods of the plurality of channel output pulses do not overlap. Active periods of the plurality of second selection signals do not overlap. The first circuit and the plurality of second circuits are driven by the same operating voltage. The first circuit and the plurality of second circuits are driven by different operating voltages.

The first circuit comprises: a level shifter converting the peak-to-peak level of the input pulse into a first level; a first transistor having a gate terminal which receives an output of the level shifter, a source terminal connected to a first supply voltage, and a drain terminal connected to a first node; a second transistor having a gate terminal which receives a first control signal, a source terminal connected to a second supply voltage, and a drain terminal connected to the first node; and a third transistor having a gate terminal connected to the first node, a source terminal connected to the second supply voltage, and a drain terminal connected to a second node, wherein the first selection signal is output via the second node.

Each of the plurality of second circuits comprises: a fourth transistor having a gate terminal which receives one of the plurality of second selection signals, a source terminal which receives the first selection signal, and a drain terminal connected to a third node; a fifth transistor having a gate terminal which receives a second control signal, a source terminal connected to a third supply voltage, and a drain terminal connected to the third node; a sixth transistor having a gate terminal connected to a fourth node, a source terminal connected to the third supply voltage, and a drain terminal connected to the third node; a first inverter inverting a logic state of a signal at the third node and outputting the inverted signal to the fourth node; and a second inverter inverting the logic state of the signal at the third node and outputting the inverted signal as one of the plurality of channel output pulses.

According to another aspect of the present invention, there is provided an apparatus for driving gate lines of an FPD comprising: a shift register receiving a start pulse and generating pulses which are sequentially activated; a plurality of shared circuits, each receiving one of the pulses from the shift register, converting a peak-to-peak level of the pulse, and outputting the converted pulse as a first selection signal; and a plurality of channel circuit groups, each including a plurality of channel circuits sharing one of the plurality of shared circuits, wherein each of the plurality of channel circuit groups generates a sequentially activated pulse according to a plurality of second selection signals while the first selection signal is active.

According to still another aspect of the present invention, there is provided a method for driving the gate lines of an FPD comprising: converting, at a first circuit, a peak-to-peak level of an input pulse; outputting, from the first circuit, the converted input pulse as a first selection signal; and generating, at a plurality of second circuits, a plurality of channel output pulses according to a plurality of second selection signals while the first selection signal is active.

The input pulse is an output pulse of a shift register. The first selection signal is synchronized with a first control signal and the plurality of second selection signals are synchronized with a second control signal.

A frequency of the second control signal is higher than a frequency of the first control signal by a factor corresponding to a number of second circuits connected to the first circuit. The second control signal is low while the first control signal is high.

Active periods of the plurality of channel output pulses do not overlap. Active periods of the plurality of second selection signals do not overlap. The first circuit and the plurality of second circuits are driven by the same operating voltage. The first circuit and the plurality of second circuits are driven by different operating voltages.

The first selection signal and the plurality of channel output pulses have the same peak-to-peak level. The first selection signal and the plurality of channel output pulses have different peak-to-peak levels. The plurality of channel output pulses are sequentially activated.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a conventional TFT-LCD;

FIG. 2 is a block diagram of a conventional gate driver;

FIG. 3 is a block diagram of a gate line driving apparatus according to an exemplary embodiment of the present invention;

FIG. 4 is a circuit diagram of a shared circuit shown in FIG. 3;

FIG. 5 is a circuit diagram of a channel circuit shown in FIG. 3; and

FIG. 6 is a timing diagram of signals for driving the gate line driving apparatus illustrated in FIG. 3.

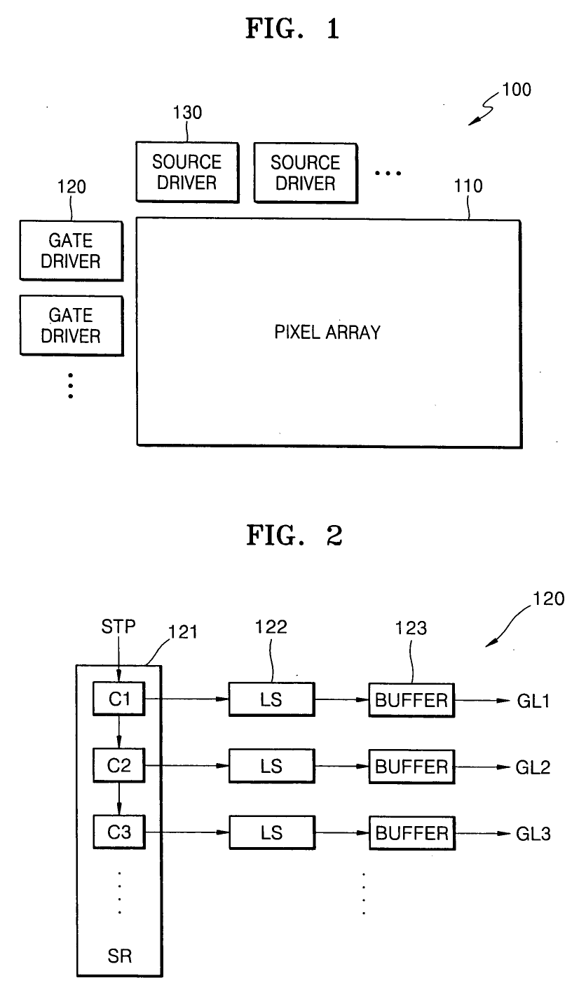

### DETAILED DESCRIPTION OF EXEMPLARY EMBODIMENTS

The present invention will now be described more fully with reference to the accompanying drawings, in which exemplary embodiments of the invention are shown.

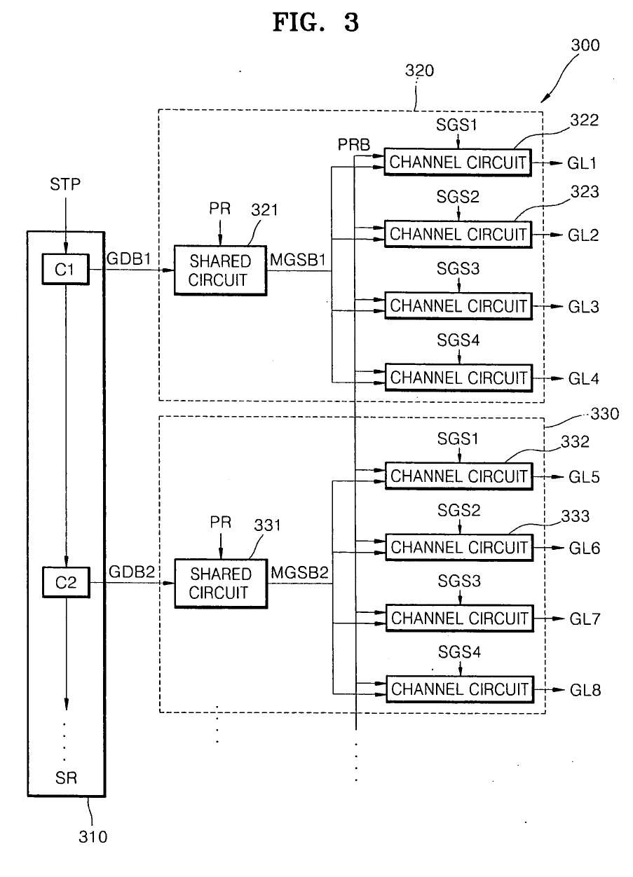

FIG. 3 is a block diagram of a gate line driving apparatus 300 according to an exemplary embodiment of the present invention. Referring to FIG. 3, the gate line driving apparatus 300 includes a shift register (SR) 310 and a plurality of shared groups 320, 330, . . .

The gate line driving apparatus 300 drives the gate lines of a Thin Film Transistor-Liquid Crystal Display (TFT-LCD). However, by slightly modifying the gate line driving apparatus 300, the gate line driving apparatus 300 may be used to drive the gate lines of different flat panel displays (FPDs) such as an Electro-Luminance (EL) display device, Super Twisted Nematic-Liquid Crystal Display (STN-LCD), Plasma Display Panel (PDP), and so forth.

In the TFT-LCD, an exemplary diagram of which is shown in FIG. 1, the TFT switching devices are disposed in correspondence with respective pixels on the lower plate of the TFT-LCD panel 110, and the gate terminals of the TFT switching devices are connected to corresponding gate lines.

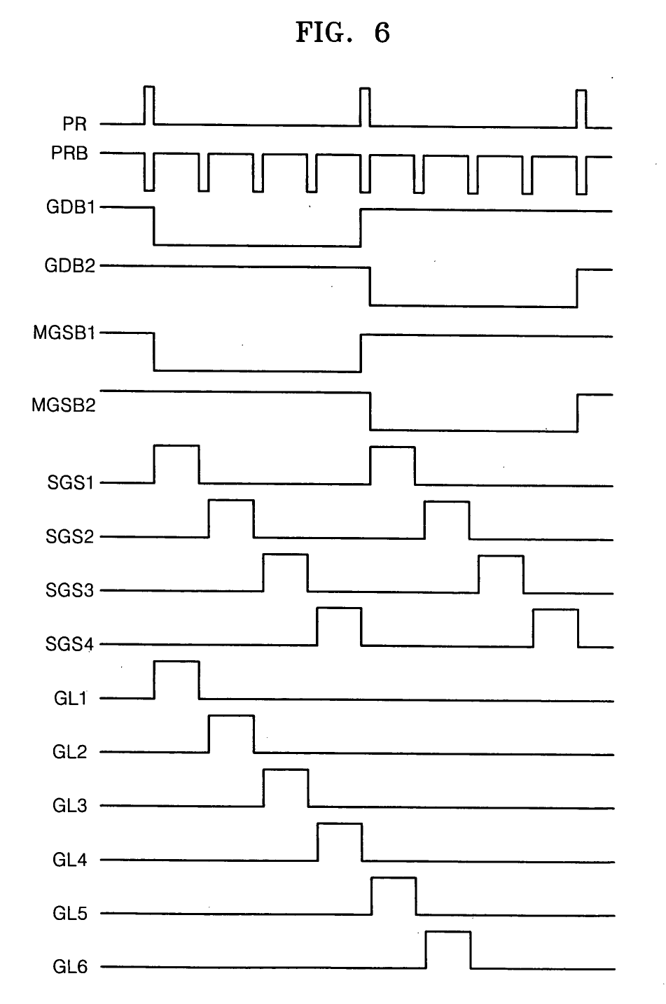

The shift register 310 includes a plurality of register cells C1, C2, . . . . If a start pulse STP is input to the shift register 310, the cells C1, C2, . . . sequentially generate active pulses GDB1, GDB2, . . . as shown, for example, in FIG. 6. In FIG. 6, the pulses GDB1, GDB2, . . . are active-low pulses that perform activation when they are low. However, the pulses GDB1, GDB2, . . . may be active-high pulses that perform activation when they are high. In the gate line driving apparatus 300, each of the sequentially activated pulses GDB1, GDB2, . . . drives one of the shared groups 320, 330, . . . and each of the shared groups 320, 330, . . . drives a plurality of gate line channels.

In FIG. 3, each of the shared groups 320, 330, . . . drives four gate line channels. For example, the first shared group 320 generates sequential active pulses GL1 through GL4 for driving four gate line channels in response to a first output pulse GDB1 received from the shift register 310. The second shared group 330 generates sequential active pulses GL5 through GL8 for driving the next four gate line channels in response to a second output pulse GDB2 received from the shift register 310.

Each of the shared groups 320, 330, . . . includes a shared circuit 321, 331, . . . and a channel circuit group. For example, in FIG. 3, the first shared group 320 includes the shared circuit 321 and a plurality of channel circuits 322, 323 . . . . The plurality of channel circuits 322, 323, . . . form a channel circuit group which shares the shared circuit 321.

The shared circuit 321 converts a peak-to-peak level of the first output pulse GDB1 received from the shift register 310 and outputs the converted pulse as a first master gate selection signal MGSB1.

The plurality of channel circuits 322, 323, . . . sequentially generate active pulses GL1 through GL4 according to a plurality of slave gate selection signals SGS1 through SGS4 while the first master gate selection signal MGSB1 is active.

In FIG. 3, the second shared group 330 includes the shared circuit 331, which is the same as the shared circuit 321, and a plurality of channel circuits 332, 333, . . . , which are the same as the plurality of channel circuits 322, 323, . . . The plurality of channel circuits 332, 333, . . . form a channel circuit group which shares the shared circuit 331.

Like the first shared group 320, the second shared group 330 generates a second master gate selection signal MGSB2 in response to the second output pulse GDB2 received from the shift register 310, and the corresponding channel circuit group sequentially activates the pulses GL5 through GL8.

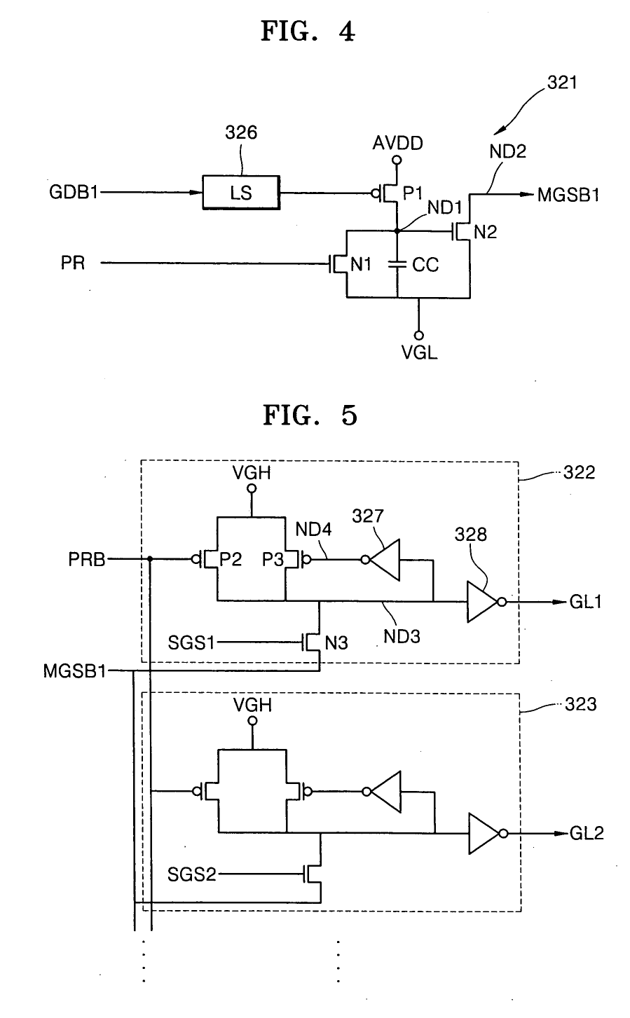

FIGS. 4 and 5 respectively illustrate circuit diagrams of the shared circuit 321 and the channel circuits 322 and 323 shown in FIG. 3. The operation of the shared circuit 321 and the channel circuits 322 and 323 will now be described with reference to FIGS. 4, 5, and 6.

Referring to FIG. 4, the shared circuit 321 includes a level shifter (LS) 326, a first P-type MOSFET (Metal-Oxide-Semiconductor Field Effect Transistor) P1, a first N-type MOSFET N1, and a second N-type MOSFET N2. The shared circuit 321 may also include a compensation capacitor CC.

The level shifter 326 converts the peak-to-peak level of the first output pulse GDB1 received from the shift register 310 into a predetermined level. For example, if the peak-to-peak level of the first output pulse GDB1 is between a reference supply voltage VDD and a ground voltage VSS, the converted pulse with the predetermined level is between a first supply voltage AVDD and the ground voltage VSS. The reference supply voltage VDD is lower than the first supply voltage AVDD.

The P-type MOSFET P1 has a gate terminal which receives an output of the level shifter 326, a source terminal connected to the first supply voltage AVDD, and a drain terminal connected to a first node ND1. The first N-type MOSFET N1 has a gate terminal which receives a first control signal PR, a source terminal connected to a second supply voltage VGL, and a drain terminal connected to the first node ND1. The second N-type MOSFET N2 has a gate terminal connected to the first node ND1, a source terminal connected to the second supply voltage VGL, and a drain terminal connected to a second node ND2. The compensation capacitor CC is connected between the first node ND1 and the second supply voltage VGL. The second supply voltage VGL is a negative voltage lower than the ground voltage VSS.

The shared circuit 321 outputs the first master gate selection signal MGSB1 via the second node ND2. As shown in FIG. 6, since the first output pulse GDB1 of the shift register 310 is an active-low pulse, the first master gate selection signal MGSB1 is an active-low pulse.

Referring to FIG. 6, when the first control signal PR is active-high, if the first output pulse GDB1 of the shift register 310 goes high in synchronization with the first control signal PR, the first master gate selection signal MGSB1 also goes high. In addition, when the first control signal PR is low, if the first output pulse GDB1 of the shift register 310 goes low in synchronization with the first control signal PR, the first master gate selection signal MGSB1 also goes low.

Meanwhile, referring to FIG. 5, the channel circuit 322 includes a third N-type MOSFET N3, a second P-type MOSFET P2, a third P-type MOSFET P3, a first inverter 327, and a second inverter 328.

The third N-type MOSFET N3 has a gate terminal which receives a first slave gate selection signal SGS1 of the plurality of slave gate selection signals SGS1 through SGS4, a source terminal connected to the first master gate selection signal MGSB1, and a drain terminal connected to a third node ND3. The second P-type MOSFET P2 has a gate terminal which receives a second control signal PRB, a source terminal connected to a third supply voltage VGH, and a drain terminal connected to the third node ND3. The third P-type MOSFET P3 has a gate terminal connected to a fourth node ND4, a source terminal connected to the third supply voltage VGH, and a drain terminal connected to the third node ND3. The first inverter 327 inverts the logic state of a signal at the third node ND3 and outputs the inverted signal to the fourth node ND4. The second inverter 328 inverts the logic state of the signal at the third node ND3 and outputs a sequentially activated pulse, for example, GL1, for driving the gate line channels.

Here, the inverters 327 and 328 operate by using the third supply voltage VGH and the second supply voltage VGL. The sequentially activated channel output pulses GL1, GL2, . . . have peak-to-peak levels between the third supply voltage VGH and the second supply voltage VGL. The shared circuit 321 and the channel circuits 322, 323, . . . can also be driven by the same operating voltage. Further, by substituting the first supply voltage AVDD of the shared circuit 321 for the third supply voltage VGH and slightly modifying the configuration of the circuit 321, the peak-to-peak level of the first master gate selection signal MGSB1 may be between the third supply voltage VGH and the second supply voltage VGL.

The channel circuit 323 for driving the next gate line channel outputs the pulse GL2 for driving the next gate line channel in response to a second slave gate selection signal SGS2 of the plurality of slave gate selection signals SGS1 through SGS4. The channel circuit 323 has the same or similar configuration as the channel circuit 322.

If the shared circuit 321 converts the peak-to-peak level of the input pulse GDB1 and outputs the converted pulse MGSB1, as shown in FIG. 6, the plurality of channel circuits 322, 323, . . . , which share the shared circuit 321, generate the sequentially activated pulses GL1, GL2, . . . in response to the plurality of slave gate selection signals SGS1, SGS2, . . . while the pulse MGSB1 is active-low.

Referring to FIG. 6, when the second control signal PRB goes high (e.g., active), if the plurality of slave gate selection signals SGS1, SGS2, . . . sequentially go high in synchronization with the second control signal PRB, the channel output pulses GL1, GL2, . . . sequentially go high. Since the active periods of the plurality of slave gate selection signals SGS1, SGS2, . . . do not overlap with each other, the active periods of the channel output pulses GL1, GL2, . . . also do not overlap with each other.

As shown in FIG. 6, the second control signal PRB has a frequency higher than that of the first control signal PR. The second control signal PRB also corresponds to the number of channels using the shared circuit 321.

For example, if the shared circuit 321 is shared by four channel circuits 322, 323, . . . of the shared group 320 as shown in FIG. 3, the second control signal PRB has a frequency four times higher than that of the first control signal PR. Further, while the first control signal PR is high, the second control signal PRB is low. In addition, the first control signal PR and the second control signal PRB enable the channel output pulses GL1, GL2, . . . to be sequentially activated in such a manner that the active periods of the channel output pulses GL1, GL2, . . . do not overlap with each other.

According to an exemplary embodiment of the present invention, if a circuit shared by a plurality of gate line channels converts the peak-to-peak level of an input pulse and outputs the converted pulse as a master gate selection signal, channel circuits connected thereto may sequentially generate channel output pulses according to corresponding slave gate selection signals while the master gate selection signal is active. Therefore, since the circuit is shared by a plurality of channels, the size and power consumption of the gate line driving apparatus may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for driving gate lines of a flat panel display (FPD), comprising:
a first circuit converting a peak-to-peak level of an input pulse and outputting the converted input pulse as a first selection signal; and
a plurality of second circuits generating a plurality of channel output pulses according to a plurality of second selection signals while the first selection signal is active.

2. The apparatus of claim 1, wherein the input pulse is an output pulse of a shift register.

3. The apparatus of claim 1, wherein the first selection signal is synchronized with a first control signal and the plurality of second selection signals are synchronized with a second control signal.

4. The apparatus of claim 3, wherein a frequency of the second control signal is higher than a frequency of the first control signal by a factor corresponding to the number of second circuits connected to the first circuit.

5. The apparatus of claim 3, wherein the second control signal is low while the first control signal is high.

6. The apparatus of claim 1, wherein active periods of the plurality of channel output pulses do not overlap.

7. The apparatus of claim 1, wherein active periods of the plurality of second selection signals do not overlap.

8. The apparatus of claim 1, wherein the first circuit and the plurality of second circuits are driven by the same operating voltage.

9. The apparatus of claim 1, wherein the first circuit and the plurality of second circuits are driven by different operating voltages.

10. The apparatus of claim 1, wherein the first circuit comprises:
a level shifter converting the peak-to-peak level of the input pulse into a first level;
a first transistor having a gate terminal which receives an output of the level shifter, a source terminal connected to a first supply voltage, and a drain terminal connected to a first node;
a second transistor having a gate terminal which receives a first control signal, a source terminal connected to a second supply voltage, and a drain terminal connected to the first node; and
a third transistor having a gate terminal connected to the first node, a source terminal connected to the second supply voltage, and a drain terminal connected to a second node,
wherein the first selection signal is output via the second node.

11. The apparatus of claim 10, wherein each of the plurality of second circuits comprises:
a fourth transistor having a gate terminal which receives one of the plurality of second selection signals, a source terminal which receives the first selection signal, and a drain terminal connected to a third node;
a fifth transistor having a gate terminal which receives a second control signal, a source terminal connected to a third supply voltage, and a drain terminal connected to the third node;
a sixth transistor having a gate terminal connected to a fourth node, a source terminal connected to the third supply voltage, and a drain terminal connected to the third node;
a first inverter inverting a logic state of a signal at the third node and outputting the inverted signal to the fourth node; and
a second inverter inverting the logic state of the signal at the third node and outputting the inverted signal as one of the plurality of channel output pulses.

12. The apparatus of claim 1, wherein the plurality of channel output pulses are sequentially activated.

13. An apparatus for driving gate lines of a flat panel display (FPD), comprising:
a shift register receiving a start pulse and generating pulses which are sequentially activated;
a plurality of shared circuits, each receiving one of the pulses from the shift register, converting a peak-to-peak level of the pulse, and outputting the converted pulse as a first selection signal; and
a plurality of channel circuit groups, each including a plurality of channel circuits sharing one of the plurality of shared circuits,
wherein each of the plurality of channel circuit groups generates a sequentially activated pulse according to a plurality of second selection signals while the first selection signal is active.

14. A method for driving gate lines of a flat panel display (FPD), comprising:
converting a peak-to-peak level of an input pulse;
outputting the converted input pulse as a first selection signal; and
generating a plurality of channel output pulses according to a plurality of second selection signals while the first selection signal is active.

15. The method of claim 14, wherein the input pulse is an output pulse of a shift register.

16. The method of claim 14, wherein the first selection signal is synchronized with a first control signal and the plurality of second selection signals are synchronized with a second control signal.

17. The method of claim 16, wherein a frequency of the second control signal is higher than a frequency of the first control signal by a factor corresponding to a number of second circuits connected to the first circuit.

18. The method of claim 16, wherein the second control signal is low while the first control signal is high.

19. The method of claim 14, wherein active periods of the plurality of channel output pulses do not overlap.

20. The method of claim 14, wherein active periods of the plurality of second selection signals do not overlap.

21. The method of claim 14, wherein the first selection signal and the plurality of channel output pulses have the same peak-to-peak level.

22. The method of claim 14, wherein the first selection signal and the plurality of channel output pulses have different peak-to-peak levels.

23. The method of claim 14, wherein the plurality of channel output pulses are sequentially activated.
